(19) United States
(12) Patent Application Publication
(10) Pub. No.: US 2008/0100054 A1
(43) Pub. Date: May 1, 2008

(54) Method and apparatus for product promotion

(76) Inventor: Paul A. Richards, Scarsdale, NY (US)

Correspondence Address: FAY KAPLUN & MARCIN, LLP, 150 BROADWAY, SUITE 702, NEW YORK, NY, 10038, US

(21) Appl. No.: 11/588,121

(22) Filed: Oct. 26, 2006

(51) Int. Cl. B42D 15/00

(52) U.S. Cl. 283/56

(57) ABSTRACT

Described is a system and method for pharmaceutical promotion. The method comprises the steps of receiving prescription data indicative of a prescribed medication, identifying a promotional item corresponding to the prescribed medication as a function of the prescription data, the promotional item being coupled to a product container, and placing the prescribed medication into the product container.

### BACKGROUND

In 1997, the Food and Drug Administration lifted marketing regulations on pharmaceutical advertising. Since that time, pharmaceutical companies have spent billions of dollars in direct-to-consumer (DTC) advertising such as, television and radio commercials, print ads, banner ads on websites, etc. However, these forms of the DTC advertising predominantly reach individuals aged 18-49, which account for approximately a quarter of the prescription drug use market. That is, individuals aged 50 and older account for a greater portion of the market, because they typically are taking three or more prescription drugs daily. However, due to government healthcare privacy regulations (e.g., HIPAA), the pharmaceutical companies are denied personal information for individuals, making targeted marketing very difficult. Thus, there is a need for a method for targeting pharmaceutical advertisements to predefined demographic and healthcare groups.

### SUMMARY OF THE INVENTION

The present invention relates to a system and method for product promotion. The method comprises the steps of receiving prescription data indicative of a prescribed medication, identifying a promotional item corresponding to the prescribed medication as a function of the prescription data, the promotional item being coupled to a product container, and placing the prescribed medication into the product container.

### BRIEF DESCRIPTION OF THE DRAWINGS

FIG. 1 shows an exemplary embodiment of an apparatus for product promotion according to the present invention.

FIG. 2 shows an exemplary embodiment of a promotional item in a folded state according to the present invention.

FIG. 3 shows an exemplary embodiment of a promotional item in an unfolded state according to the present invention.

FIG. 4 shows an exemplary embodiment of a product container display in a closed state according to the present invention.

FIG. 5 shows an exemplary embodiment of a product container display in an opened state according to the present invention.

FIG. 6 shows an exemplary embodiment of a method for generating a promotional program according to the present invention.

FIG. 7 shows an exemplary embodiment of a method for generating a promotional item according to the present invention.

FIG. 8 shows an exemplary embodiment of a method for implementing a promotional program according to the present invention.

FIG. 9 shows an exemplary embodiment of a system for product promotion according to the present invention.

### DETAILED DESCRIPTION

The present invention may be further understood with reference to the following description and the attached drawings, wherein like elements are referred to with the same reference numerals. The exemplary embodiments of the present invention describe a system and method for product promotion. In the exemplary embodiment, a promotional item is selected based on a pharmaceutical prescribed to a customer and attached to a pharmaceutical bag that will be used to transfer the prescribed pharmaceutical to the customer. Thus, a manufacturer of a pharmaceutical advertised on the promotional item is ensured that the promotional item reaches its intended target, e.g., individual taking a competing pharmaceutical, individual suffering from ailment treated by manufacturer's pharmaceutical, individual in a predefined healthcare population (e.g., age, gender, ethnicity, etc.). While the exemplary embodiments of the promotional item will be described with reference to promotion of a pharmaceutical, those of skill in the art will understand that any service and/or consumer item may be promoted using the promotional item. For example, the promotional item may be utilized for grocery products, books, electronic devices, video rentals, etc.

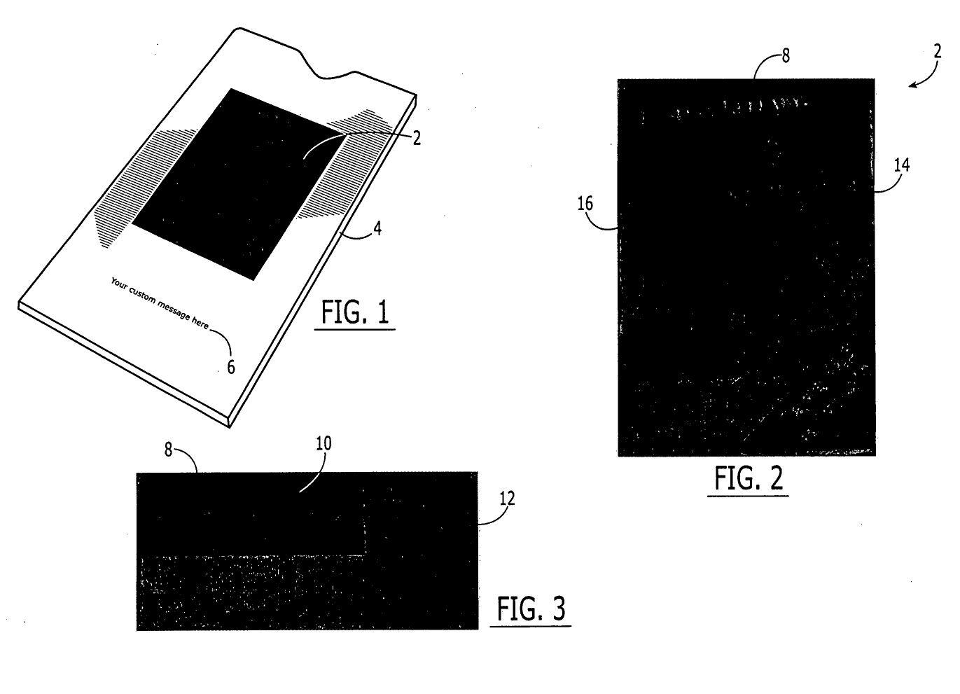

FIG. 1 shows an exemplary embodiment of an apparatus (or item) for product promotion that comprises a promotional item 2 coupled to a product container 4 or housing. The promotional item 2 includes product-related data and/or graphics including, but not limited to, product information, a coupon, a rebate, a product sample, a business reply card, a set of instructions (e.g., dosages, side effects, etc.), a sweepstakes entry, a data storage device (e.g., a minidisc, memory stick/card, etc), manufacturer information, retailer information, etc. The product-related data may be directed at one or more products, which may include a product being transferred to the customer in the product container 4. While the exemplary embodiment of the promotional item 2 will be described as a multi-page pamphlet, those of skill in the art will understand that the promotional item 2 may include any number of pages, including a single page and may be printed on any type of print-receiving medium (e.g., card stock, fabric, etc.). The product-related data may be printed in color or monochrome and in one or more languages. In a further embodiment, the promotional item 2 may be printed directly on an outer surface of the product container 4.

In the exemplary embodiment, the product container 4 is a pharmaceutical bag similar to those used by a pharmacist to transfer a prescription medication to a customer. Thus, in the exemplary embodiment, the product container 4 does not come into direct contact with the product (e.g., the prescribed medication), but instead holds a product package (e.g., a prescription medication bottle) containing the product. In other exemplary embodiments, the product container 4 may be an envelope or package (e.g., a shipping container). In another exemplary embodiment, the promotional item 2 may be coupled to product packaging, clothing, the product itself, a receipt, a bill of sale, a circular, an informational booklet, etc. The product container 4 may include a message 6 printed thereon adjacent to a position to which the promotional item 2 will be attached. The message 6 may be, for example, a product manufacturer, retailer and/or distributor trade/service mark, logo and/or slogan, an instruction regarding the promotional item 2 (e.g., how to detach, information contained therein, etc.), an instruction regarding the product container 4 (e.g., how to open/close, how to dispose, contents, etc.), etc. In other exemplary embodiment, the message 6 may be printed on a label (or other medium) which is coupled to the product container 4. In this manner, different combinations of messages and promotional items may be disposed on the product container 4.

The promotional item 2 may be attached to the product container 4 using a pressure sensitive attachment arrangement. For example, one or more perforated edges of the promotional item 2 may be coupled to complementary perforated edges formed on an outer (visible) surface of the product container 4. Alternatively, an adhesive may couple the promotional item 2 to the product container 4. Those of skill in the art will understand that various other mechanical (e.g., staples, clasps, etc.) and chemical means may be utilized to attach the promotional item 2 to the product container 4. Preferably, removal of the promotional item 2 from the product container 4 does not damage the product container 4.

FIGS. 2 and 3 show exemplary embodiments of the promotional item 2 in folded and unfolded (opened) states, respectively. When the promotional item 2 is the multi-page pamphlet, it may comprise, at least, a cover page 8 and a back page 10. As stated above, the pages of the pamphlet may include the product-related data in text and/or graphics. The cover page 8 may include a leading edge 14 which is separable from the back page 10, and a bound edge 16 for opening the promotional item 2 like a book. The leading edge 14 may be coupled to the back page 10 using, for example, perforations or the mechanical or chemical means discussed above. Preferably, a first pressure required to separate the leading edge 14 of the cover page 8 from the back page 10 is less then a second pressure required to remove the promotional item 2 from the product container 4 and/or a third pressure required to remove the cover page 8 entirely from the back page 10 (e.g., if the cover page 8 is a coupon, business reply card, etc.). When the promotional item 2 is in the folded and/or unfolded states, it may be any shape or size.

The promotional item 2 may further include an intermediate page 12. In this manner, the promotional item 2 may be bound like a book or have pages that open away from each other forming a panorama, as shown in FIG. 3. Each of the pages 8, 10, 12 may include the product-related data. However, a rear side of the back page 10 may not include the product-related data if it is used to couple the promotional item 2 to the product container 4 (e.g., it may be covered in a layer of adhesive).

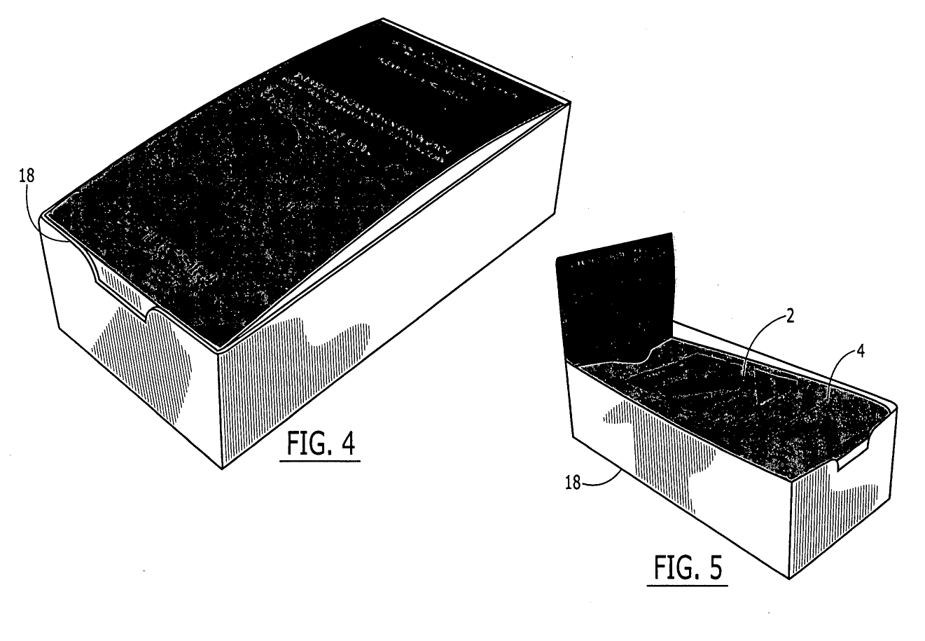

FIGS. 4 and 5 show an exemplary embodiment of a product container display 18 in closed and open states, respectively. The display 18 may be used to ship, display and/or dispense the product container 4 and may include the product-related data printed thereon. In the closed state in FIG. 4, the display 18 may be shaped like, for example, a shoebox or any other shape that, preferably, conforms to a shape of the product container 4, reducing space required for shipping and storage behind a pharmacy counter. In the open state in FIG. 5, the display 18 is reconfigured to uncover the product containers 4 therein, which are preferably oriented so that the promotional items 2 are immediately visible. Additionally, in the open state, it is preferable that the product-related data on the promotional item 2 and/or the display 18 is immediately visible, ensuring that the pharmacist is visually aware of the promotional item 2. In other exemplary embodiments, the display 18 may be a bag, rack, bin, etc. for holding the product containers 4.

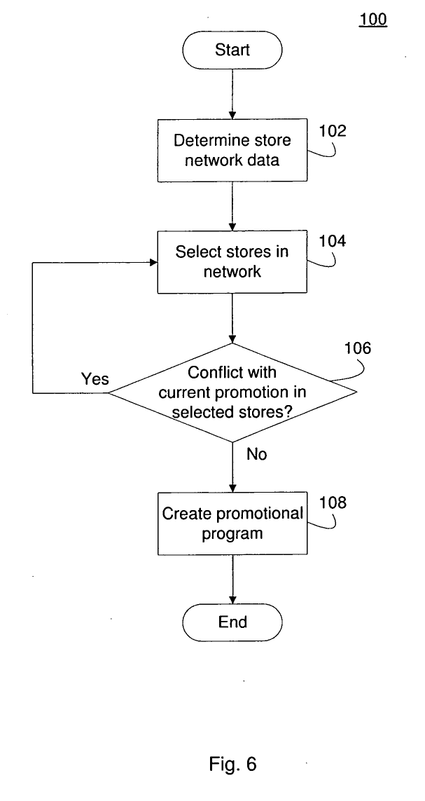

FIG. 6 shows an exemplary embodiment of a method 100 for generating a promotional program according to the present invention. As stated above, while the exemplary embodiment of the method 100 will be described with reference to promotion of a pharmaceutical, those of skill in the art will understand that the method 100 may be utilized for promoting other products and/or services. Those of skill in the art will further understand that the method 100 may be implemented in hardware and/or software on a computing device. That is, the steps of the method 100 may be embodied as instructions stored in memory and executed by a processor.

In step 102, store network data is determined. The store network data may include a number of stores in which a promotional program will be executed, a number of prescriptions filled for a predefined pharmaceutical in a predefined time period, any other promotional program that previously, currently or are expected to be run in the stores, a geographic location of each of the stores, etc. Those of skill in the art will understand that the term ‘store’ may refer to any means by which a pharmaceutical may be obtained which includes, but is not limited to, brick and mortar establishments, mail order companies, online retailers, etc. For example, a pharmaceutical company that manufactures a blood-thinner may want information regarding the number of prescriptions for all blood thinner prescriptions (their own and their competitors'), filled in each of the stores. Based on the number of prescriptions, the pharmaceutical company may be able to target selected stores which are filling prescriptions for their competitors' blood-thinners.

In step 104, a plurality of the stores in the network is selected to execute the promotional program. The stores may be selected, for example, individually, by geographic region, population of surrounding area, number of customers serviced, total number of prescriptions filled, the number of prescriptions filled for a predefined pharmaceutical, etc.

In step 106, it is determined whether running the promotional program in the selected stores would conflict temporally with a currently running promotional program for a competing pharmaceutical. For example, if the currently running promotional program is promoting a competing blood thinner in the selected stores, the pharmaceutical company may be precluded from promoting their blood thinner. Those of skill in the art will understand that the conflict check may be performed globally or on a store-by-store basis for each store in the network. If there is a conflict with a currently running promotional program, a further plurality of stores may be selected which includes previously unselected stores and/or stores in which there is no conflict with the currently running promotional program (e.g., return to step 104). In other embodiments, the promotion program may be non-exclusive and step 106 may be skipped. Those of skill in the art will understand that a marketing company may perform the conflict check in step 106, for example, only internally based on the stores in its own network.

In step 108, none of the selected stores have a currently running promotion program which conflicts with the pharmaceutical company's pharmaceutical, so the promotional program may be created.

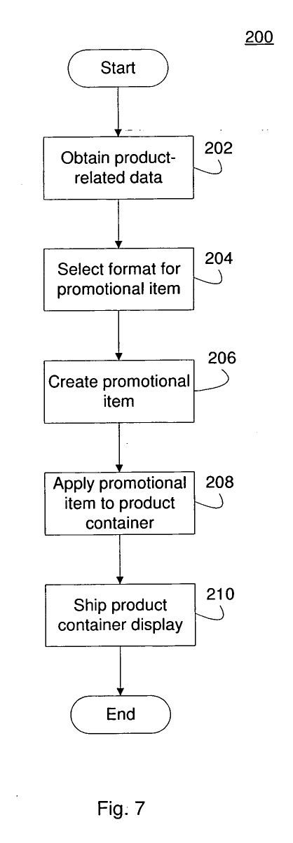

FIG. 7 shows an exemplary embodiment of a method 200 for generating the promotional program according to the present invention. In step 202, the product-related data is obtained from, for example, the pharmaceutical company. Those of skill in the art will understand that the product-related data may be generated automatically by, for example, compiling and selecting the product-related data from a source (e.g., database, scanned information, promotional materials, etc.). In step 204, a format for the promotional item 2 is selected based on the product-related data. For example, a number of pages in a pamphlet may be adjusted and/or a size of the promotional item 2 may be changed based on the amount and/or type of the product-related data. In step 206, the promotional item 2 is generated based on the product-related data and the selected format. As stated above, the promotional item 2 may be embodied as any one or combination of a pamphlet, a booklet, a coupon, a rebate, a product sample, a business reply card, a set of instructions, a sweepstakes entry, a data storage device (e.g., a minidisc, memory stick/card, etc), etc.

In step 208, the promotional item 2 is attached to the product container 4 and packaged in the product container display 18. As stated above, any mechanical and/or chemical means may be utilized to couple the promotional item 2 to the product container 4. In step 210, the displays 18 are shipped to the stores included in the promotional program.

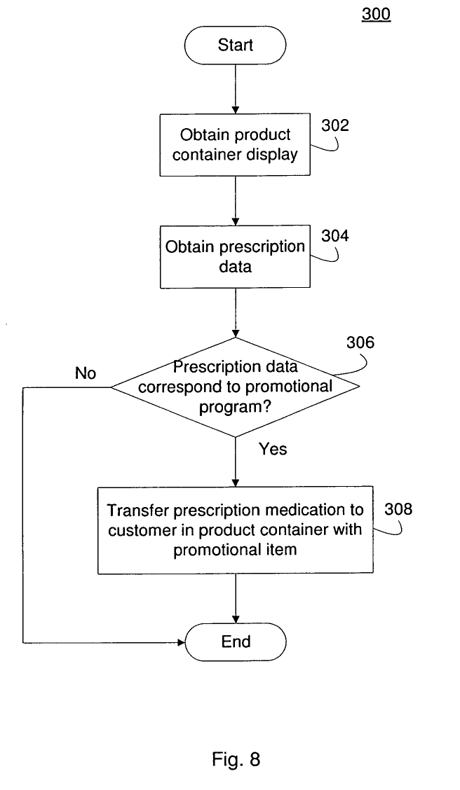

FIG. 8 shows an exemplary embodiment a method 300 of implementing the promotional program according to the present invention. In step 302, the product container display 18 is obtained by, for example, the pharmacist. In one exemplary embodiment, the display 18 may include an instruction letter to the pharmacist explaining, for example, how to set up the display 18, the pharmaceutical being promoted, how to implement the promotional program, how to redeem/obtain a coupon, sweepstakes entry, discount, etc. The instruction letter may further include an incentive item for the pharmacist to use the display 18 and the product containers 4 therein. For example, a sweepstakes entry, product coupon/discount/rebate, etc. may be included with the instruction letter, which the pharmacist can redeem.

In step 304, prescription data corresponding to a prescription medication that is to be filled for a customer is obtained. For example, the prescription data may include a name of the prescription medication, drug class, affliction treated by the prescribed medication, customer data (e.g., age, gender, ethnicity, medical history, previous/current prescription medications, etc.), etc.

In step 306, it is determined whether the prescription data corresponds to the pharmaceutical being promoted. For example, the prescription medication being filled may be a sleep therapy drug, e.g., Ambien®, and the pharmaceutical being promoted may be a different sleep therapy drug, e.g., Lunesta®. Because the prescription data corresponds to the pharmaceutical being promoted, the pharmacist may transfer the prescription medication to the customer in the product container 4 with the promotional item 2 attached thereto, as shown in step 308. Thus, the pharmaceutical company can be satisfied that the promotional item 2 is reaching an individual who (i) suffers from an ailment treated by their pharmaceutical and (ii) is not currently a user of their pharmaceutical. While the exemplary embodiment of the method 300 has been described with reference to promoting a competing pharmaceutical, those of skill in the art will understand that the promotion program may be focused on promoting the pharmaceutical to current users and/or non-users.

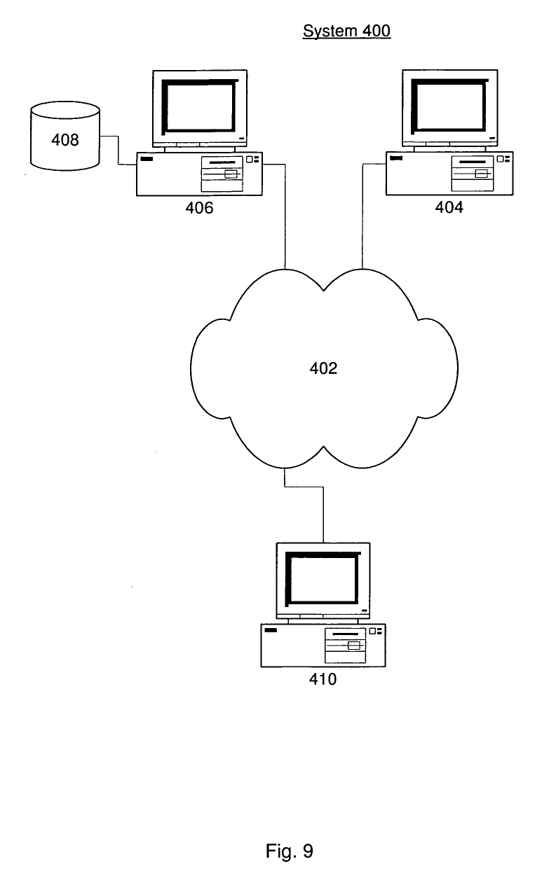

FIG. 9 shows an exemplary embodiment of a system 400 for product promotion according to the present invention. A communications network 402 (e.g., a wired/wireless local/wide area network, the Internet, a PSTN, etc.) interconnects several computing devices allowing for data-sharing therebetween. For example, a marketing server 404 may communicate with a manufacturer server 406 to exchange data related to a promotional item for a product of the manufacturer. That is, the marketing server 404 may obtain the product-related data stored in a database 408 on the manufacturer server 406 and may generate the promotional item 2 from the product-related data. The promotional item 2 (formatted as a data file) may be downloaded to a pharmacy computer 410 via the network 402. The promotional item 2 may then be printed on the product containers 4 when the customer gets a prescription filled. Additionally, as stated above the pharmacist may be provided a sweepstakes entry that can be entered on a website hosted on the server 404.

Those of skill in the art will understand that the system 400 allow for other product promotion implementations. For example, as the promotional items 2 are used at the pharmacy, a pharmacist may enter use data into the pharmacy computer 410 which is then harvested by the servers 404 and/or 406 to track the promotional program, optionally, anticipate a time for re-supplying the promotional items 2 to the pharmacy. In another exemplary embodiment, the pharmacy computer 410 may receive updated product-related data from the server 406 and/or report customer satisfaction/survey results regarding the manufacturer's product.

In a further exemplary embodiment, the product container 4 and the promotional item 2 may be shipped separately to the pharmacist. Thus, the pharmacist can select a promotional item corresponding to the prescription data, attach the selected promotional item to the product container 4 and transfer the prescription medication to the customer in a product container 4. In this or any other exemplary embodiment, the pharmacist may select the promotional item based on a request by the customer and/or other ailments suffered by the customer (e.g., as evidenced by previously and/or currently prescribed medication). In this embodiment, the pharmacist may attach more than one promotional item to each product container.

In another exemplary embodiment, the promotional item 2 may be a message which is printed on the product container 4 based on the prescription data. For example, the pharmacist or an automated service (e.g., automate call-in program, Internet application/applet, etc.) may receive the prescription data and select a promotional item based thereon. The promotional item may then be printed on the product container, and, optionally, include a personalization. For example, the message may state, “Larry, thank you for fulfilling your prescription here. Redeem this coupon for Lunesta® for a 5% discount, should you decide to switch to Lunesta®.” The coupon may include color graphics and/or text. In this embodiment, the product container 4 may already include some of the product-related data, but the message may be further included to personalize/customize the promotional item 2. This embodiment may be embodied as a software program executed on a computing device used by the pharmacist. The software program may analyze the prescription data and select the promotional item thereon, as well as generating the personalized message to be printed on the product container.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
receiving prescription data indicative of a prescribed medication;
identifying a promotional item corresponding to the prescribed medication as a function of the prescription data, the promotional item being coupled to a product container; and
placing the prescribed medication into the product container.

2. The method according to claim 1, wherein a medical professional executes at least one of the receiving, identifying and placing steps.

3. The method according to claim 1, wherein the product container is one of a pharmacy bag, an envelope and a product packaging.

4. The method according to claim 1, wherein the promotional item includes product-related data corresponding to a further medication.

5. The method according to claim 4, wherein the product-related data includes at least one of a coupon, a rebate, a discount, dosage information, side effects, retailer information and manufacturer information.

6. The method according to claim 4, wherein the identifying includes:
selecting the promotional item when an ailment treated by the prescribed medication is substantially similar to an ailment treated by the further medication.

7. The method according to claim 1, wherein the identifying includes:
selecting the promotional item as a function of at least one of (i) an age of the customer, (ii) a gender of the customer, (iii) an ethnicity of the customer, (iv) medical information about the customer, (v) at least one previous prescription medication prescribed for the customer and (vi) at least one current prescription medication prescribed for the customer.

8. The method according to claim 1, wherein the promotional item is at least one of a pressure-sensitive label, a sticker, a business reply card, a minidisc, a memory stick and a product sample.

9. The method according to claim 1, wherein the prescription data includes at least one of (i) a name of the prescription medication, (ii) a drug class of the prescription medication, (iii) an ailment treated by the prescription medication and (iv) customer data.

10. The method according to claim 9, wherein the customer data includes at least one of (i) an age of the customer, (ii) a gender of the customer, (iii) medical information about the customer, (iv) at least one previous prescription medication prescribed for the customer and (v) at least one current prescription medications prescribed for the customer.

11. A promotional arrangement, comprising:
a product container holding a first prescription medication; and
a promotional item coupled to an outer surface of the product container, the promotional item including product-related data for a second prescription medication that treats an ailment substantially similar to an ailment treated by the first prescription medication.

12. The promotional arrangement according to claim 11, further comprising:
a product container display storing the product container and having the product-related data displayed on a portion thereof.

13. The promotional arrangement according to claim 11, wherein the product container is one of a pharmacy bag, an envelope and a product packaging.

14. The promotional arrangement according to claim 11, wherein the product-related data includes at least one of a coupon, a rebate, a discount, dosage information, side effects, retailer information and manufacturer information.

15. The promotional arrangement according to claim 11, wherein the promotional item is at least one of a pressure-sensitive label, a sticker, a business reply card, a minidisc, a memory stick and a sample of the second medication.

16. The promotional arrangement according to claim 11, wherein the promotional item includes further product-related data corresponding to a third prescription medication.

17. A method, comprising:
receiving product-related data corresponding to a pharmaceutical product;
selecting a promotional item format based on the product-related data;
generating a promotional item based on the promotional item format and the product-related data; and
attaching the promotional item to a pharmacy bag.

18. The method according to claim 17, wherein the promotional item format is one of a single-page card, a multi-page pamphlet and a portable storage device.

19. The method according to claim 17, wherein the pharmacy bag includes source information indicative of at least one of (i) a retailer selling the pharmaceutical product and (ii) a manufacturer of the pharmaceutical.

20. The method according to claim 19, wherein the source information includes at least one of a trademark, a logo and a slogan.
